(19) United States
(12) Patent Application Publication
(10) Pub. No.: US 2009/0319991 A1
(43) Pub. Date: Dec. 24, 2009

(54) Managed code type equivalence

(75) Inventors: Michael Shneerson, Redmond, WA (US); Raja Krishnaswamy, Redmond, WA (US); Shrikrishna V. Borde, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/143,572

(22) Filed: Jun. 20, 2008

(51) Int. Cl. G06F 9/44

(52) U.S. Cl. 717/120

(57) ABSTRACT

The determination of whether two managed code types are of equivalent types on the basis of a comparison between type identifiers of the managed types. The type identifiers may be independent of an assembly in which the managed types are created, a namespace of the corresponding managed type, or a name of the corresponding managed type. Accordingly, the type equivalence determination may be made to be quite flexible, thereby potentially resulting in better type equivalence determinations in of managed types.

### BACKGROUND

Programmers author computer programs by using source code. In order for that source code to be executed by a computer, the source code must first be compiled or interpreted into machine code (sometimes called “binary”) that may be directly executed by the processor(s) the computer. In “unmanaged” code, that source code is directly compiled into machine code that may be directly executed by a target computing system or a compatible of the compilation process. Originally, computer programs were typically, if not always, authored using unmanaged code, although the term “unmanaged” has not been widely used to describe such code until the advent of what is now termed “managed” code.

Managed code, on the other hand compiles to an intermediate language, rather than machine code. The intermediate language code is kept in an intermediate code file sometimes referred to as an “assembly”. During execution time, the assembly is read by the computing system. One of the first tasks that are performed in the execution of the assembly is the loading of a runtime. Then, as methods are called by the intermediate language code, the runtime causes the corresponding methods to be compiled by a Just-In-Time or (JIT) compiler, whereupon the resulting machine code is executed.

The JIT compiler and runtime are familiar with and have access to the execution environment. Thus, the JIT compiler can compile the intermediate code into machine code specific to the computing system that is executing the assembly. In addition, the runtime may use this local execution environment familiarity to provide additional services that are typically not provided in unmanaged code unless expressly provided for in the unmanaged code. Such additional services may include security, memory management, threading, and the like. Thus, the managed code is said to be “managed” by the runtime.

In managed code or in unmanaged code systems, there are a number of occasions both at compile-time and at run-time in which it is helpful to know whether two references to a type (hereinafter also referred to as “type references” or perhaps just “types”) refer to equivalent types. If they are equivalent, then either the types are identical, or they are or may be transformed to be sufficiently the same that they may be considered to be the equivalent in a certain context. For example, when a function call is placed, the calling module may express one or more input parameters to provide to the called module. The called module will likewise expect to receive structures of a particular type when called. A type equivalence check may be performed in this case to make sure that the function call is valid. There are a wide variety of other contexts in which a type equivalence check would be helpful.

Some unmanaged code expresses the type of an object in the form of a Globally Unique Identifier or “GUID”. In Component Object Model (COM) code, for example, an arbitrary type is identified by its Globally Unique Identifier (GUID). Each GUID is guaranteed to be unique, so any type can be assigned a GUID that can thereafter reliably be considered to be its unambiguous identity.

On the other hand, in managed code, an arbitrary type is identified by the as strong name of the assembly where it is defined, plus the namespace and type name of the type. Two types which have the same namespace and name, but are defined in different assemblies are considered to be different types. Also, two types which have the same GUID attribute, but different namespace/names and/or different assemblies are also considered to be different types.

### BRIEF SUMMARY

Embodiments described herein allow for the determination of whether two managed code type references are of equivalent types. The equivalence type determination is made on the basis of a comparison between type identifiers of the managed code type references. In one embodiment, the type identifiers are independent of an assembly in which the managed code types are defined, a namespace of the corresponding managed code type, and/or a name of the corresponding managed code type. Accordingly, the type equivalence determination may be made to be quite flexible on the basis of a type identifier of a managed code type.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a managed code environment that includes managed code type references;

FIG. 3 illustrates a flowchart of a method for determining whether two or more type references should be treated as equivalent types;

FIG. 4 illustrates an environment in which the type identifier of a managed code type is created and persists across one or more transformations of the managed code type;

FIG. 5 illustrates a flowchart of a method for transforming a managed code type reference in a manner that a type is preserved, and may be performed in the environment of FIG. 4; and

FIG. 6 illustrates a flowchart of a method for imposing type safety at the time that a type identifier is assigned to a managed code type.

### DETAILED DESCRIPTION

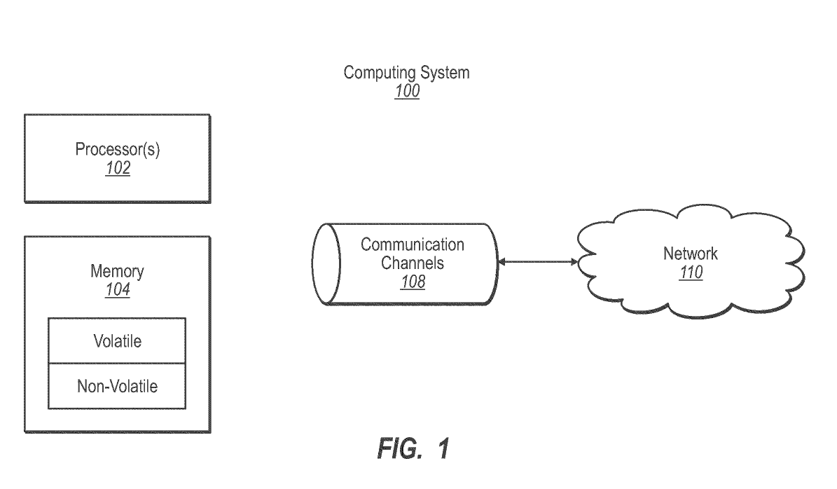

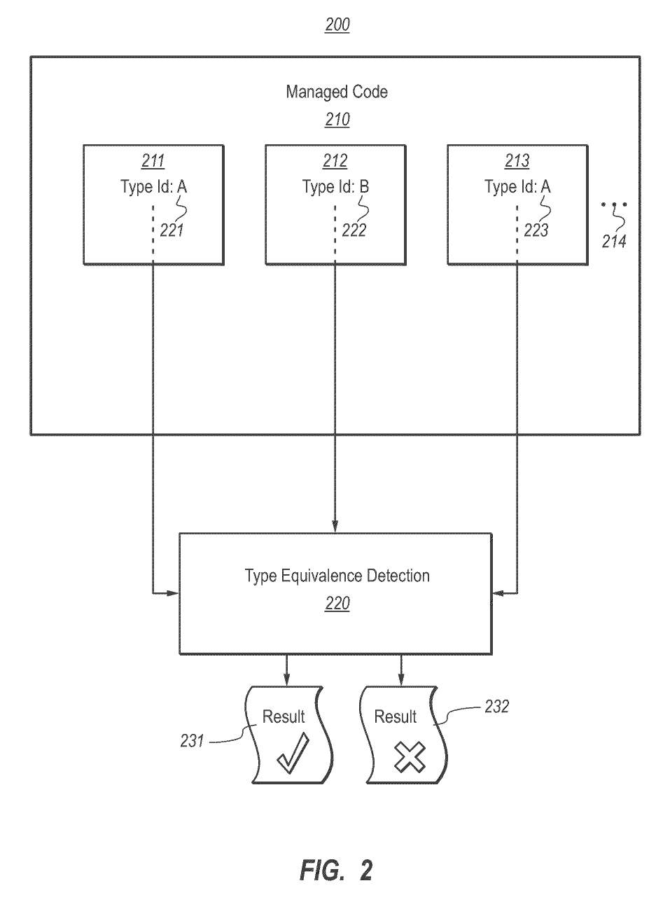

In accordance with embodiments described herein, a determination of whether type references are of equivalent types is made on the basis of a comparison between type identifiers, even though one or both of the type references are managed code types. The type identifiers are independent of an assembly in which the managed code types are defined. First, some introductory discussion regarding computing systems will be described with respect to FIG. 1. Then, various embodiments of mechanism for determining type equivalence of managed code types will be described with respect to FIGS. 2 through 6.

Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memor” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and as wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates a managed code environment 200 that includes a portion of managed code 210. The managed code 210 may be in the process of being compiled, in which case the type equivalence detection is facilitating compilation at compile-time when the source code is compiled into intermediate code. The managed code 210 may also be in the process of being executed, in which case the type equivalence detection is facilitating execution at run-time when the intermediate code is converted to machine code and executed (if not previously executed on the machine) or run from machine code (if previously executed on the machine). The managed code 210 may be a portion of a single program, or may be portions of different programs. The managed code may even be considered to be any code that is managed in the sense that it is compiled specifically at runtime using a Just-In-Time (JIT) compiler that is adapted to the specific execution environment. Because the JIT compiler is aware of the actual execution environment, the JIT compiler may add code that provides security, memory management, and/or other functions using the awareness of the local execution environment while determining and enabling type equivalence.

The managed code 210 is illustrated as including a number of type references that are accessible in the managed code 210. If the type equivalence determination is made at run-time, then the type equivalence determination might be made for purposes of comparing the type of an object to some other given type reference. If that is the case, the type of the object is determined, and it is the type of the object that is used for comparing against the given type, rather than the object that is compared against the given type. In this example of FIG. 2, the managed code is illustrated as including three managed code type references 211, 212 and 213, although the ellipses 214 represents that the managed code may have additional type references. Such types might include structures, interface, methods, properties or any other piece of type. Such types are defined by a corresponding schema.

Type references are equivalent if the objects of those types have an identical structure, or at least they have a structure such that one or both of the objects may be transformed such that they may be treated as equivalent. Type equivalence determination is helpful in a number of contexts. The principles described herein are not limited to any one context. However, as an example, type equivalence is advantageous when evaluating a function call to determine whether the function call is valid. For instance, when a function call is placed from a calling module to a called module, the signatures of the calling method are checked from the standpoint of both modules. As part of that process, the types for the parameters to the method are verified for type equivalency to validate that this is a proper function call.

In FIG. 2, each of managed code type includes a type identifier. For instance, managed code type 211 includes a type identifier of “A”, managed code type 212 includes a type identifier of “B”, and managed code type 213 includes a type identifier of “A”. In this case, the type identifiers of managed code type references 211 and 213 match (because they are both “A”). Therefore, even if the types are somewhat different, they will be determined to be equivalent. The type identifiers may be any identifier that is unique to that type. In one embodiment, the type identifier is a Globally Unique IDentifier (GUID).

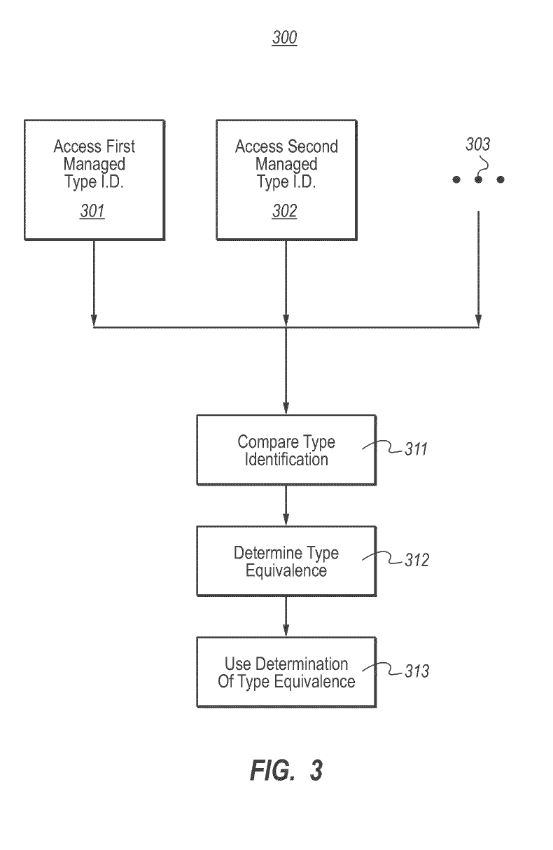

FIG. 3 illustrates a flowchart of a method 300 for determining whether two or more type references are equivalent types. The type identifier for each type to be compared is accessed. In a case where there are two types that are being compared, the type identifier for a first managed code type is obtained (act 301), and as the type identifier for a second type is obtained (act 302). The second type may be a managed code type or an unmanaged code type. In the case of a type equivalence determination for three of more types, the type identifier(s) for other types may be accessed as well as represented by the ellipses 303. In FIG. 2, for example, the type equivalence detection module 220 may access the type identifiers 221, 222 and 223, respectively, for any two or more of types 211, 212, and 213. In this description, unless otherwise specified, the modifiers “first”, “second” and so forth, are merely to distinguish one item from another, and not to describe any order related to the items. For instance, the “first” managed code type may be accessed after the “second” type.

In one embodiment, the type identifier corresponds to a single property of the type, with perhaps no constituent portion of the type identifier being taken from another property of the type. For managed code type, this contrasts with the conventional mechanism for detecting type equivalence in which the type equivalence determination is based on a strong name that is a combination of the assembly in which the managed code type is defined, the namespace of the managed code type, and the name of the managed code type. The type identifiers of FIG. 2 are independent of the assembly in which the managed type is created, the namespace of the managed type, and/or the name of the managed type.

Once the type identifiers are accessed for the types be analyzed for equivalence, the type identifiers are compared (act 311). On the basis of this comparison, the type equivalence of the objects may be determined (act 312). For instance, referring to FIG. 2, assume for a moment that type equivalence is determined based on whether the type identifiers for the corresponding types match. In FIG. 2, if the types 211 and 212 were compared, this would result in a negative determination 232 of type equivalence since type 211 has a type identifier of A and as type 212 has a type identifier of B. For this same reason, a comparison of type identifiers 222 and 223 would result in a negative type equivalence determination. However, a comparison of type identifiers 221 and 223 would result in a positive type equivalence determination 231 as between types 211 and 213.

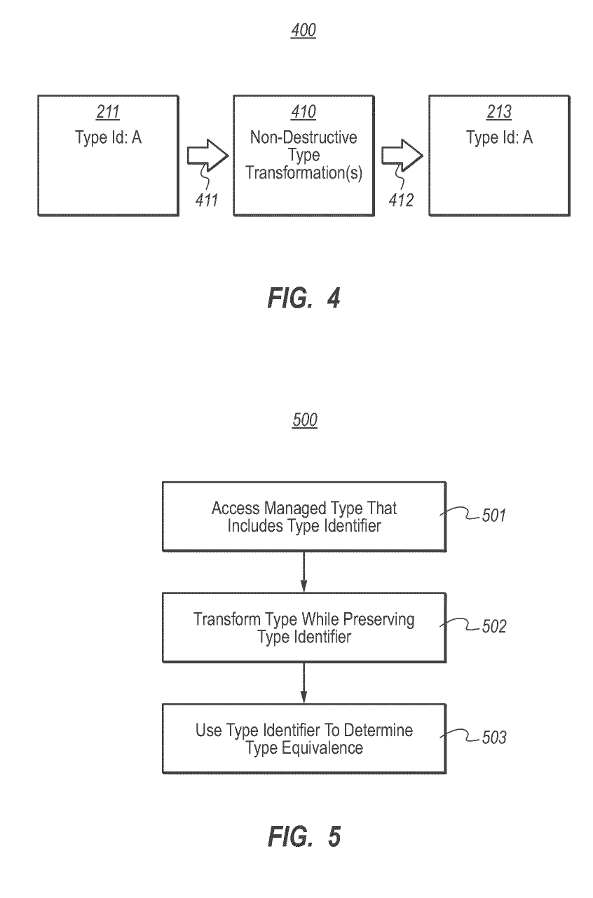

FIG. 4 illustrates an environment 400 in which the type identifier of a managed type is created and persists across one or more transformations of the managed type. Specifically, the managed type 213 of FIG. 2 may be a transformed version of the managed type 211 of FIG. 2 as represented in FIG. 4. The managed type 211 is provided through a non-destructive transformation process(es) 410 that does not impact the type identifier to result in a new managed type 213 that retains the same type identifier that was present in the managed type before the transformation. As an example, the transformation(s) 410 might include the generation of a specific type based on a generic type, importing the managed type into an assembly, changing the namespace of the managed type, or even changing the name of the managed type or changing the name or customize the signature of some of the methods to signatures with equivalent types.

FIG. 5 illustrates a flowchart of a method 500 for transforming a managed type in a manner that a type is preserved, and may be performed in the environment 400 of FIG. 4. The method 500 includes accessing a managed type that includes a durable type identifier (act 501). For instance, in FIG. 4, the managed type 211 is accessed. Next, the managed type is transformed in a manner that the durable type identifier is preserved (act 502). For instance, in FIG. 4, the managed type 211 is transformed to another managed type 213 while the type identifier (in this case, “A”) is preserved. The preserved durably type identifier is as then used to detect type equivalence of the managed type with another type (act 503). For instance, the type identifier may be used to determine type equivalence as illustrated and described with respect to FIGS. 2 and 3.

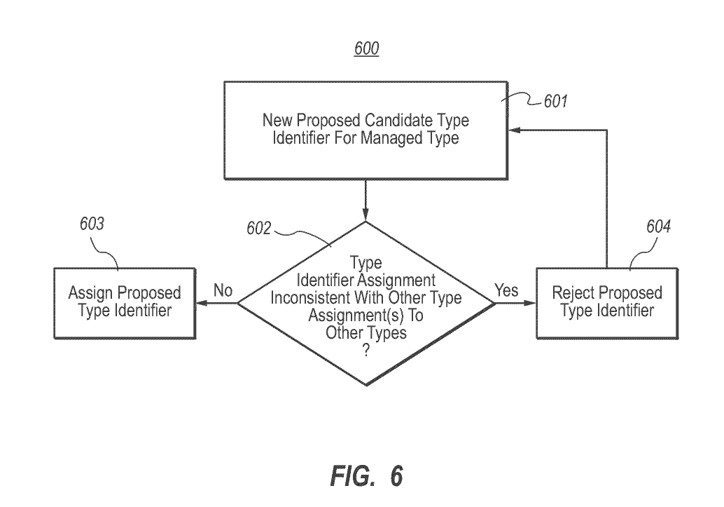

The type identifier should preferably be assigned such that they do not lead to an incorrect conclusion regarding type equivalence. For instance, if there is a type identifier for a particular managed type, the same type identifier should not be used for another type unless the two types truly are of the same type or are equivalent types. Accordingly, FIG. 6 illustrates a flowchart of a method 600 for imposing type safety at the time that a type identifier is assigned to a managed type.

Upon determining that a candidate type identifier is proposed to be associated with a managed type (act 601), it is determined whether or not the proposed candidate type identifier is inconsistent with type identifiers that have been previously assigned to other types (decision block 602). For instance, in the case where an identical type identifier in indicative of type equivalence, if a type identifier is proposed to be assigned to a managed type that has already been assigned to another object that is not equivalent, then that assignment would be inconsistent.

If the type identifier assignment is not likely to be inconsistent (No in decision block 602), the proposed candidate type identifier is assigned as the type identifier for the managed type (act 603). Otherwise, (Yes in decision block 602), the proposed candidate type identifier is rejected (act 604), and another proposed candidate type identifier is awaited for (act 601), or otherwise the process ends without assigning a type identifier.

Accordingly, the principles described herein provide an effective and efficient mechanism for determining type equivalence in a managed type environment. The present invention may be embodied in other specific forms without as departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for determining whether two types should be treated as equivalent, the method comprising:
an act of accessing a type identifier of a first managed type;
an act of accessing a type identifier of a second type;
an act of comparing the type identifiers associated with the first managed type and the second type; and
an act of determining type equivalence of the first managed type and the second type on the basis of the act of comparing the type identifiers.

2. A method in accordance with claim 1, wherein the second type is a second managed type.

3. A method in accordance with claim 2, wherein the type identifier of the first and second managed types are independent of an assembly in which the first and second managed types, respectively, are created.

4. A method in accordance with claim 3, wherein the type identifier of the first and second managed types are independent of a namespace of the first and as second managed types, respectively.

5. A method in accordance with claim 4, wherein the type identifier of the first and second managed types are independent of a name of the first and second managed types, respectively.

6. A method in accordance with claim 3, wherein the type identifier of the first and second managed types are independent of a name of the first and second managed types, respectively.

7. A method in accordance with claim 2, wherein the type identifier of the first managed and second managed types are independent of a namespace of the first and second managed types, respectively.

8. A method in accordance with claim 7, wherein the type identifier of the first and second managed types are independent of a name of the first and second managed types, respectively.

9. A method in accordance with claim 1, wherein the type identifier of the first and second managed types are independent of a name of the first and second managed types, respectively.

10. A method in accordance with claim 1, wherein the type identifiers of the first and second managed types are each unique identifiers.

11. A method in accordance with claim 10, wherein the type identifiers of the first and second managed types are each Globally Unique Identifiers or GUIDs.

12. A method in accordance with claim 1, wherein the type identifier of the first managed type is a single property of the first managed type.

13. A method in accordance with claim 12, wherein the type identifier of the second managed type is a single property of the second managed type.

14. A method in accordance with claim 1, wherein a direct match of the type identifier of the first managed type and the type identifier of the second managed type would result in a determination of equivalent type.

15. A method in accordance with claim 1, further comprising:
an act of using the resulting of the act of determining type equivalence in order to bridge two type systems.

16. A method for transforming a managed type in a manner that a type identifier is preserved, the method comprising:
an act of accessing a managed type that includes a durable type identifier;
an act of transforming the managed type in a manner that the durable type identifier is preserved; and
an act of using the preserved durable type identifier in order to detect type equivalence of the managed type with another type.

17. A method in accordance with claim 16, wherein the act of transforming comprises an act of pulling the managed type into an assembly.

18. A computer program product comprising one or more computer-readable media having thereon computer-executable instructions that, when executed by one or more processors of a computing system, cause the computing system to perform a method comprising:
an act of determining that a candidate type identifier is proposed to be associated with a managed type;
an act of estimating whether or not the proposed candidate type identifier is less likely to be inconsistent with the same proposed candidate type identifier being assigned to one or more other types;
if it is determined that the proposed candidate type identifier is less likely to be inconsistent, an act of allowing the proposed candidate type identifier to be assigned as a type identifier for the managed type; and
if it is determined that the proposed candidate type identifier is not less likely to be inconsistent, an act of rejecting the proposed candidate type identifier.

19. A computer program product in accordance with claim 18, wherein the one or more computer-readable media are physical memory and/or storage media.

20. A computer program product in accordance with claim 19, wherein upon rejecting the proposed candidate type identifier, the method is iterated again for as another candidate type identifier that is proposed to be associated with the managed type.
